(19) United States
(12) Patent Application Publication
(10) Pub. No.: US 2008/0020090 A1
(43) Pub. Date: Jan. 24, 2008

(54) Novel Fermentation Process and Uses Therefore

(76) Inventors: Robert McCaig, Winnipeg (CA); Trenton Baisley, Regina (CA); Ken Sawatzsky, Winnipeg (CA)

Correspondence Address: MIDDLETON & REUTLINGER, 2500 BROWN & WILLIAMSON TOWER, LOUISVILLE, KY, 40202, US

(21) Appl. No.: 11/777,757

(22) Filed: Jul. 13, 2007

(30) Foreign Application Priority Data
Jul. 18, 2006 (CA) 2552693
Jul. 13, 2007 (CA) 2583817

(51) Int. Cl. C12C 11/00; A23J 1/00; A23L 1/00; C12C 3/00; C12C 7/28; A23L 1/212; A23L 1/27

(52) U.S. Cl. 426/16; 426/250; 426/28; 426/443; 426/49; 426/506; 426/600; 426/656

(57) ABSTRACT

A method of producing a liquid fermentation product using a natural protein concentrate from a non-cereal grain source in place of protein derived from malted grains is provided. The natural protein concentrate can be directly used, in addition with a carbohydrate source, to produce a wort suitable for fermentation, thus avoiding the malting and mash mixing steps in traditional brewing methods. The wort requires less yeast to initiate the fermentation process than in similar alcohol fermentations, and does not require the addition of yeast nutrients. The resulting fermentation product can be processed for bottling without the need for an intervening storage period. The protein concentrate used in the method can be derived from non-cereal sources such as peas, soy, rice potatoes and other sources of natural protein. Using non-cereal sources also permits the simplified production of a gluten-free fermentation product that can be used in preparing beverages consumable by persons suffering from gluten intolerance.

### FIELD OF THE INVENTION

This invention is in the field of fermentation and brewing processes, and in particular the use of natural protein sources in the form of a concentrate for use in fermentation and brewing processes.

### BACKGROUND

The brewing of beers and similar beverages using various fermentation methods has been practiced for centuries. The brewing of beers typically makes use of a malted grain as a primary source of fermentable sugars. The process of malting involves allowing the grain to germinate, followed by drying and in some cases roasting of the germinated grain. Allowing the grain to germinate results in the activation of enzymes within the grain kernel (e.g. amylases), which convert the starch in the grain into fermentable sugars. These fermentable sugars are subsequently converted by yeast to alcohol and carbon dioxide during the fermentation process.

After malting, the malted grain is crushed to form grist. The grist is mixed with heated water in a vessel producing a mash. During mashing and mixing of the mash, various natural enzymes operate to hydrolyze starch into sugars, as well as to break down other components of the grain such as beta glucans. Proteinases in the mash are also important to degrade some of the grain proteins that if left unprocessed, can result in a hazy appearance to the final fermented product. Once mashing is completed, the liquid is then separated from the grain in a process termed lautering. Lautering separates the grain extract from the spent grains. Additional water may also be used to further rinse the grains free of the desired components, in a step and process termed sparging.

The liquid at this stage is termed the wort, and it is the wort that is the main ingredient in the beer fermentation process. Prior to fermentation, the wort is typically heated to boiling and it is common at this time to add various flavoring agents. In traditional beers, hops, herbs and other sugars may be included at this stage of the brewing process to provide additional flavoring or fermentable materials. Boiling the wort inactivates enzymes, precipitates proteins and aids in extracting and modifying flavoring compounds derived from added materials (e.g. isomerization of hops resins) prior to starting fermentation.

The wort is next transferred to a fermentation vessel and fermentation of the wort is initiated by the addition of yeast. Yeast converts sugars to alcohol and carbon dioxide via glycolysis. The amount of alcohol produced during fermentation depends on a number of factors, including the type of yeast, the amount of sugar in the wort, and the time and temperature of fermentation. For lager style beers fermentation typically proceeds for 7-10 days, while for ales a shorter fermentation of 4-7 days is typical.

Following fermentation beers are usually stored for periods ranging from 7-21 days. During storage, yeast and other particulates settle out of the beer. The beer is then subsequently filtered and bottled. In total, prior art methods of beer production require from 3-4 weeks to complete, and require a number of specialized pieces of equipment, especially for the malting of grain, mixing of the mash, the sparging procedure and for the storage of the product following fermentation. Each step in the brewing process requires time and energy. Thus it would be desirable to have a method that can eliminate some of the steps of brewing without adversely affecting the quality or quantity of the final fermentation product.

It is also desirable on occasion to produce “beers” or fermented alcoholic beverages that are not derived from cereal grains in order to avoid the inclusion of gluten in the finished product. Gluten is a complex of the proteins gliadin and glutenin and is commonly found in wheat, rye, oats and triticale. It comprises up to 80% of the protein in the grain. In genetically predisposed persons, gluten causes an autoimmune reaction that may result in impairment of nutrient absorption as well as irritation of the gastrointestinal tract, a syndrome known as celiac disease. Celiac patients are thus required to avoid the consumption of sources of carbohydrate that contain gluten.

Methods for the production of gluten-free beers have been described. For example, German Patent Application DE/102005020639 (Werner el al.) discloses a method for producing brown malt from gluten-free grains (e.g. millet, buckwheat, amaranth and/or quinoa) suitable for use in a brewing process. Similarly, Canadian Patent Application No. 2,266,234 (Ragg el al.) discloses a method for producing a gluten-free beer using non-gluten containing grains such as buckwheat, sorghum or millet. These non-gluten grains are prepared for use in a brewing process by the addition of saccharifying enzymes to convert the starches in the gluten-free grains to fermentable sugars. An analogous process is disclosed in Canadian Patent Application No. 2,268,506 (Ragg el al.) where amylase and glucanase are added to a mixture comprising buckwheat and rice malt to produce a fermentable mixture. Likewise, Canadian Patent Application No. 2,189,268 discloses a method wherein raw potatoes are treated with a strong mineral acid to produce an extract that is then treated enzymatically to produce a clear juice suitable for use in the production of a gluten-free beer.

However, each of these methods for producing gluten-free fermentation products requires steps such as malting, or additional treatments above and beyond that required for regular brewing methods, such as acid treatment or addition of enzymes to break down starches. Therefore, the production of gluten-free “beer” is generally more complicated than standard brewing techniques, and thus more costly and time-consuming. Therefore, it would be desirable to provide a method of brewing a gluten-free fermentation product that avoided the need for additional chemical or enzymatic treatments, and which does not require a malting step.

Finally, traditional brewing methods usually include a storage or condition step during which time particulates are allowed to settle out of the fermentation product. Such a step usually takes from 7-21 days, adding to the time and thus the cost of producing a fermentation product like a beer. It would be desirable to provide a method of brewing that does not require a storage or condition step following fermentation in order to reduce the overall time required for the entire brewing process.

### SUMMARY OF THE INVENTION

A natural protein concentrate, along with a carbohydrate source, can be used in place of malted grains in a brewing process to produce a fermentation product with some of the desirable qualities of beers made from grains. It is therefore an object of the invention to provide a method of brewing that makes use of a natural protein concentrate in place of cereal grains to produce a fermentation product suitable for consumption.

It has also been discovered that the use of the natural protein concentrate from a non-cereal grain source outlined herein avoids the need for the malting, mash mixing and wort separation, steps typically used in prior art brewing methods that convert starches in grains to fermentable sugars so that the wort is suitable for fermentation. Thus, it is an additional object of the invention to provide a brewing method in which the malting, mash mixing and wort separation steps are not required to produce a fermentable wort.

It has also been discovered that the use of a natural protein concentrate in such a fermentation method obviates the need for artificially added yeast nutrients such as di-ammonium phosphate or urea. Thus, it is yet another object of the invention to provide a method of fermentation wherein the use of a natural protein concentrate eliminates the need for diammonium phosphate, urea or other artificial additives as yeast nutrients. It is another object of the invention to provide a method of producing a fermented beverage product that makes use of the natural protein concentrate and carbohydrate source and avoids the need for a malting step such as is used in a conventional brewing process.

In persons who are gluten-intolerant, the consumption of gluten causes a gastrointestinal disorder known as celiac disease. It is a further object of the present invention to provide a gluten-free fermentation product, suitable for use in producing alcoholic beverages that may be safely consumed by persons who are gluten-intolerant.

Thus, the overall objects of the present invention are to provide a method of brewing using a natural protein concentrate that removes the need for the malting, mash mixing and storage steps of a typical fermentation during the course of brewing, to produce a fermentation product with many of the qualities of a beer brewed by traditional methods. This simplified method of brewing for beer without malt reduces the time and equipment required for brewing, thus resulting in significant cost savings over traditional brewing methods.

In a first aspect, a method for the production of a wort for use in the production of liquid fermentation products wherein the wort contains a natural protein concentrate from a non-cereal grain source in the place of malt is provided. The method comprises: first combining a natural protein concentrate from a non-cereal grain source with water to create a protein water admixture; next, boiling the protein water admixture to produce a wort; and purifying the boiled wort by removal of non-desired compounds or impurities. Various methods of purification of the boiled wort can be conceived, including allowing the boiled wort to rest, stratifying impurities for removal, and subsequently removing any non-desirable settled compounds from the stratified wort.

The method also can optionally comprise cooling the boiled wort, either during or after the purification step, in advance of the subsequent use of the wort in the fermentation process for the production of liquid fermentation product.

The method of production of the wort outlined herein might also include the addition of at least one fermentable sugar to the protein water admixture in advance of the boiling of the wort. Fermentable sugars which are contemplated to potentially be effective include sucrose, fructose, glucose, molasses and honey. It will however be understood to one skilled in the art that a number of different types of fermentable sugars might be used either singly or in combination and that all such variations on the method of the production of wort outlined herein are contemplated within the scope of the present invention.

Bittering agents such as hops or a natural extract of hops might also be added to the protein water admixture in advance of the preparation of the wort, as may be one or more different flavoring or coloring compounds (such as caramel) which might be understood or known to one skilled in the art of brewing.

The use of a gluten-free source to produce the natural protein concentrate used in the method of wort production outlined herein can result in the production eventually of a gluten-free or relatively gluten-free liquid fermentation product from the wort.

In certain circumstances it might be desirable to produce a concentrated wort for the sake of extending shelf stability or otherwise producing a wort which could be stored or shipped more easily by virtue of its volume, etc. A concentration step could be added to the method of wort production whereby following the boiling of the protein water admixture, to produce the wort, either before or after purification the wort could be concentrated in to either a concentrated liquid or dry form. Any number of different types and methods of concentration techniques will be understood to one skilled in the art and all are contemplated within the scope hereof Basically, any type of a concentration method which resulted in a wort concentrate which could subsequently be reconstituted by the addition of water for use in a fermentation process is contemplated to be within the scope of this aspect of the present invention.

The wort which is produced in accordance with this method of production of wort for use in the production of liquid fermentation product without the reliance on malt is contemplated within the scope of the present invention as well as the liquid fermentation product which results from the conduct of the fermentation using the wort. In this aspect of the invention, a method of production of a liquid fermentation product without reliance on malt comprises:
a) Initiating fermentation within a fermentation vessel by combining yeast with a wort containing a natural protein concentrate from a non-cereal grain source in place of malt; and
b) Allowing fermentation within the fermentation vessel to continue at a selected fermentation temperature for a period of time being the fermentation time period, until the desired liquid fermentation product is produced therein.

The wort which is used in the process for preparation of the liquid fermentation product can either be produced contemporaneously or in advance of the conduct of the remainder of the fermentation process, or might alternatively be a wort which is previously produced in accordance with the remainder of the invention outlined herein. In the case where the wort is to be produced contemporaneously with the remainder of the fermentation process, the process for the production of a liquid fermentation product might further comprise, in advance of initiation of fermentation within a fermentation vessel, producing the wort for use in the remainder of the method by:
c) combining a natural protein concentrate from a non-cereal grain source with water to create a protein water admixture;
d) boiling the protein water admixture to produce a wort; and
e) purifying the boiled wort by removal of non-desired compounds or impurities.

Where the wort is produced immediately in advance of the remainder of the fermentation process it might be desirable to cool the wort to a preselected fermentation temperature, or where a wort is otherwise previously manufactured it may be necessary to bring the wort to the selected fermentation temperature either by heating or cooling that product.

Once the fermentation has proceeded to the point that the desired finished fermentation profile is reached within the fermentation vessel, the fermentation could be stopped using various conventional means understood to one skilled in the art.

The fermentation method of the present invention might be practiced using a concentrated wort requiring reconstitution with water to the proper concentration in advance of use in fermentation, and wherein the concentrated wort is properly reconstituted to the desired concentration for fermentation by the addition of water in advance of the initiation of fermentation within the fermentation vessel.

The addition of yeast to the wort to initiate fermentation might be done at varying levels as would be understood or adjusted by one skilled in the art of beverage fermentation. It is specifically contemplated that yeast are added to the wort at a concentration in the range of from 0.5-2.0 million cells per degree Plato.

The fermentation method of the present invention might also be modified by the addition of oxygen injection into the fermentation vessel during the fermentation process, to aid in the fermentation taking place therein. While the parameters of oxygen injection again could be varied by one skilled in the art, it is specifically contemplated that the oxygen might be injected into the wort within the fermentation vessel at a concentration in the range of 5-40 parts per million.

The liquid fermentation product produced by the fermentation process of the present invention could be finished, following fermentation by conducting at least one of filtering, carbonation, blending, coloring or flavoring the liquid fermentation product. Where the liquid fermentation product was finished by blending with at least one other liquid, the second product with which the liquid fermentation product is blended might be any number of different beverages or beverage components including another fermented product produced from a malted grain such as a fully fermented beer. The period of time within which the fermentation is conducted as well is the temperature at which fermentation is conducted again or parameters which could be adjusted by those skilled in the art. It is specifically contemplated however that the fermentation is conducted within the fermentation vessel for a period of time in the range of 4 to 14 days, and that the fermentation temperature is m the range of 10 to 22 degrees Celsius.

Where the natural protein concentrate used within the wort is produced from a gluten-free source, a gluten-free or low gluten beverage or liquid fermentation product could be produced in accordance with the fermentation process of the present invention. The final lo product, the liquid fermentation product, of the fermentation process of the present invention could be either on its own or following flavoring or blending, a beverage which could be packaged for consumption or a beverage component which could be packaged for blending or use in the production of downstream drink products.

The combination of the natural protein concentrate and the fermentable corn syrup designed for use in the fermentation method of the present invention replaces the malted grains used in traditional brewing methods. Malting is normally required to convert the starches present in grains into simpler sugars that are fermentable by yeast to produce alcohol. Malting of grains requires the germination, then grinding, drying and sometimes roasting of the grain. Removing the need for malting would provide a significant advantage over traditional brewing methods in that the overall process would be simplified, and would avoid the need for specialized equipment required for malting.

In addition, by avoiding the use of grains, the present method likewise eliminates the need for mash mixing and sparging steps that are required to produce a wort suitable for fermentation. As mash mixing and lautering steps are performed in separate vessels and at elevated temperature, the present brewing method provides a savings in terms of time, equipment and energy expenditure, thus simplifying and improving the economics of the brewing process.

Thus, the method of the present invention is simpler, avoids the requirement for the specialized equipment needed for malting, and reduces the time needed for the overall brewing process by eliminating the mating, mash mixing and sparging steps.

The combination of the natural protein concentrate and the fermentable corn syrup designed for use in the fermentation method of the present invention replaces the malted grains used in traditional brewing methods. Malting is normally required to convert the starches present in grains into simpler sugars that are fermentable by yeast to produce alcohol. Malting of grains requires the germination, then grinding, drying and sometimes roasting of the grain. Removing the need for malting would provide a significant advantage over traditional brewing methods in that the overall process would be simplified, and would avoid the need for specialized equipment required for malting.

In addition, by avoiding the use of grains, the present method likewise eliminates the need for mash mixing and sparging steps that are required to produce a wort suitable for fermentation. As mash mixing and lautering steps are performed in separate vessels and at elevated temperature, the present brewing method provides a savings in terms of time, equipment and energy expenditure, thus simplifying and improving the economics of the brewing process.

Various flavorings and colorings known in the art of brewing may be combined with the fermentation product obtained by the present method to yield various final product taste profiles.

Furthermore, the fermentation product produced by the method of the invention can be made gluten-free if desired. The product so obtained is thus suitable for blending with other components to produce a wide range of alcoholic beverages suitable for consumption by persons suffering from gluten intolerance.

Thus, the method of the present invention is simpler, avoids the requirement for the specialized equipment needed for malting, and reduces the time needed for the overall brewing process by eliminating the malting, mash mixing and sparging steps. In one aspect of the invention these would include commonly used flavorings like hop extracts, herbs, brewer's caramel and other additives well known to those skilled in the art. Other embodiments would make use of other additives and flavorings or coloring well known in the art and suitable for preparing alcoholic beverages for consumption. The use of such added materials will thus be chosen based on the desired preferences of the brewer, or of the consumer for which the fermentation product is being prepared

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a flow chart detailing a prior art brewing method;

FIG. 2 is a flow chart demonstrating one embodiment of the method of production of a wort for use in a fermentation process in accordance with the present invention;

FIG. 3 is a flow chart demonstrating one embodiment of a method of the production of a concentrated wort in accordance with the present invention whereby a wort which can subsequently be reconstituted to the appropriate concentration for use in a fermentation process by the addition of water is produced;

FIG. 4 is a flow chart outlining one embodiment of a fermentation method in accordance with the present invention;

FIG. 5 is a flow chart outlining another embodiment of a fermentation method in accordance with the present invention, wherein concentrated wort is used to commence the fermentation and the reconstitution of the wort to the appropriate concentration in advance of the commencement of fermentation is shown;

FIG. 6 is a flow chart outlining an embodiment of a method of production of a liquid fermentation product in accordance with the present invention wherein the method includes the production of the soft as well as the injection of oxygen into the fermentation step;

FIG. 7 is a flow chart of another embodiment of the method of production of a liquid fermentation product in accordance with the present invention demonstrating the incorporation of flavorings into the final liquid fermentation product following fermentation; and

FIG. 8 demonstrates one embodiment of the method of production of a blended beverage using the liquid fermentation product of the fermentation method of the present invention as a beverage component.

### DETAILED DESCRIPTION OF THE INVENTION

It has been recently discovered that cereal grains typically used in traditional methods of brewing can be replaced by a natural protein concentrate, along with a source of fermentable sugar such as a corn syrup to produce a wort suitable for use in a brewing process. It is thus an object of the invention to provide a method of brewing that makes use of a natural protein concentrate in place of cereal grains. The natural protein concentrate can be produced by either wet or dry processes known to those skilled in the art. Conveniently, the natural protein concentrate can be derived from a number of sources including peas, rice, soy, potatoes and the like. Other sources of protein will also be readily adaptable for use in the brewing method of the invention, and thus the source of protein is not meant to limit the scope of the invention in any way.

### Prior Art;

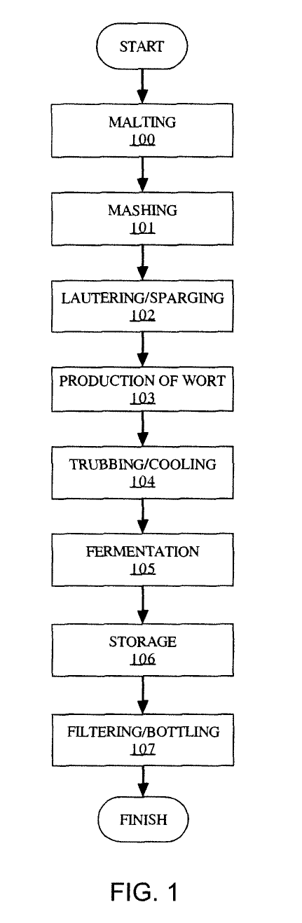

The various benefits and manufacturing advantages of the process of the present invention as well as the finished product of the process of the present invention can be seen by comparing the invention to prior art brewing methods. FIG. 1 demonstrates one example of a prior art brewing method, and outlines all of the various steps typically used in those methods for the sake of comparison with the optimized or streamlined method of the present invention.

FIG. 1 demonstrates one prior art brewing method which is demonstrated here for the sake of illustrating the efficiency or enhancement of the process of the present invention over those methods currently used in the prior art. Referring to that Figure, there is demonstrated the first step 100 in the typical prior art brewing method which is that of the malting step. The process of malting involves allowing the grain to germinate, followed by drying and in some cases roasting of the germinated grain. Allowing the grain to germinate results in the activation of enzymes within the grain kernel (e.g. amylases), which convert the starch in the grain into fermentable sugars. These fermentable sugars are subsequently converted by yeast to alcohol and carbon dioxide during the fermentation process. Insofar as the parameters of the malting process can have a significant outcome on me the flavor profile of the finished brewed product, the malting step is typically conducted by a brewer, requiring them to have the necessary equipment at their disposal.

The next step 101 in a typical prior art brewing process is the mashing step. The malted grain is crushed, to grist which is mixed with heated water in a vessel producing a mash. During mashing and mixing of the mash, various natural enzymes operate to hydrolyze starch into sugars, as well as to break down other components of the grain such as beta glucans.

Once mashing is completed, the liquid is then separated from the gram m a process step in termed lautering 102. Lautering separates the grain extract from the spent grains. Additional water may also be used to further rinse the grains free of the desired components, in a step and process termed sparging.

The liquid at this stage is termed the wort, and it is the wort that is the main ingredient in the beer fermentation process. Preparation of the wort for fermentation is shown in FIG. 1 at Step 103. Prior to fermentation, the wort is typically heated to boiling and it is common at this time to add various flavoring agents. Boiling the wort inactivates enzymes, precipitates proteins and aids in extracting and modifying flavoring compounds derived from added materials (e.g. isomerization of hops resins) prior to starting fermentation.

Following boiling of the wort, shown at 103, the next step in a typical prior art to fermentation process, such as that demonstrated in FIG. 1, is the cooling and resting of the wort, also referred to as “trubbing” which accomplishes two objectives: firstly to cool the hot wort down to the appropriate temperature at which fermentation can be initiated by the addition of yeast [since a wort which is too hot will kill the yeast]; and secondly, by resting and cooling the wort, impurities and undesirable compounds, including residual spent materials and the like, can be settled off of the wort for removal. The trubbing step is demonstrated in this Figure at 104.

Following the completion of wort preparation, fermentation can finally be commenced. The fermentation stage of the brewing process is shown at Step 105 in FIG. 1. The wort is next transferred to a fermentation vessel and fermentation of the wort is initiated by the addition of yeast. Yeast converts sugars to alcohol and carbon dioxide via glycolysis. The amount of alcohol produced during fermentation depends on a number of factors, including the type of yeast, the amount of sugar in the wort, and the time and temperature of fermentation. For lager style beers fermentation typically proceeds for 7-10 days, while for ales a shorter fermentation of 4-7 days is typical.

Following fermentation beers are usually stored for periods ranging from 7-21 days. During storage, yeast and other particulates settle out of the beer. The beer is then subsequently filtered and bottled. The storage and final handling steps are shown at 106 and 107. In total, prior art methods of beer production require from 3-4 weeks to complete, and require a number of specialized pieces of equipment, especially for the malting of grain, mixing of the mash, the sparging procedure and for the storage of the product following fermentation. Each step in the brewing process requires time and energy.

The prior art method of FIG. 1 is demonstrated herein for the purpose of outlining the procedurally efficiency accomplished by the processes of the present invention. Specifically, the malting, mashing and sparging steps have been removed from the typical brewing or fermentation process in accordance with the present invention, as well as the storage step. Removal of these steps will significantly reduce the amount of equipment and overhead required to conduct brewing, in addition to the economic efficiency of the actual fermentation process itself in terms of the quantity and type of ingredients used.

Natural Protein Concentrate:

The core of the present invention is the discovery that the use of a natural protein concentrate obtained from a non-cereal grain source in the preparation of a wort for use in fermentation processes used to produce liquid fermentation products such as beer and the like, results in the ability to remove the malting step from a traditional brewing process which not only reduces substantially the cost and complexity of the brewing process but also the use of this type of a natural protein concentrate to produce a wort for use in fermentation, whereby the fermentation process itself will not be reliant upon the presence of malt in the wort to feed the yeast, can also result in the production of a liquid fermentation product that is either devoid of or very low in gluten.

The general category then of sources of the natural protein concentrate which is used in the production of the wort for use in the remainder of the fermentation process of the present invention is non-cereal grains. It will be understood that the use of a natural protein concentrate from any non-cereal grain in the production of a wort or in any fermentation process outlined in the remainder of this document is contemplated within the scope of the present invention.

Certain non-cereal grains are also either low in or devoid of gluten. The use of a natural protein concentrate obtained from those particular starting materials can result in the end product being either gluten-free or very low in gluten. It will be understood that the ability to produce gluten-free fermented beverage products is a major commercial benefit to the process of the present invention, but even beyond the potential to produce gluten-free products, the general production of fermented beverage products and other liquid fermentation products without the use of malt, regardless of the presence of gluten, represents a significant economic and time efficiency in the production of liquid fermentation products over methods presently used.

The actual method of preparation or recovery of natural protein concentrates from non-cereal grains for use in a fermentation wort will be understood to those skilled in the art of seed processing. The specific method of recovery of the protein concentrate, beyond the requirement that it be a natural nonchemical method, might vary and it will be understood that any method resulting in the production or recovery of a natural protein concentrate from non-cereal grain is contemplated within the scope of the present invention.

Production of wort:

At the heart of the modified brewing or fermentation process of the present invention is the production and use of a wort which does not rely on malt and rather in its place replaces the malt in the wort with a natural protein concentrate from a non-cereal grain source. The removal of reliance upon malt as an active ingredient in the wort removes the need for the malting steps from the prior art fermentation methods considered and yields significant process efficiencies. As outlined elsewhere herein, the replacement of the malt in the wort with a natural protein concentrate from a non-cereal grain source, also potentially results in a wort and finished fermentation liquid which is either low in or does not contain gluten, depending upon the source of the natural protein concentrate and any other ingredients added to the wort or to the fermentation process. Minimization or removal of gluten from the finished process is another added, albeit not necessarily linked, commercial benefit of the modified fermentation process of the present invention for use in the production of liquid fermentation products such as beverages and beverage components.

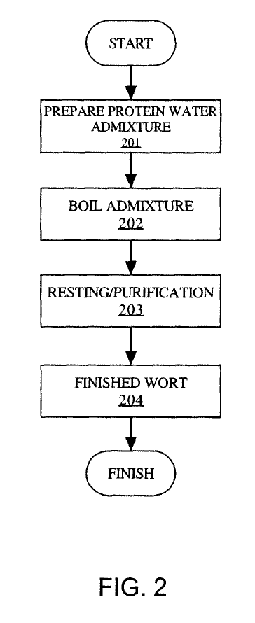

FIG. 2 is a process flow diagram demonstrating one embodiment of a method for production of a wort for use in liquid fermentation in accordance with the present invention. It is specifically contemplated that the production of a wort for use in liquid fermentation using the natural protein concentrate from a non-cereal grain source as outlined herein comprises not only an intermediate step in a larger fermentation process but also the production of the wort for subsequent use is contemplated within the scope of an the present invention. It is specifically contemplated that by virtue of the simplification of the fermentation process of the present invention, versus prior art brewing processes or techniques such as that demonstrated in FIG. 1, that it may be practically speaking more economical for more small brewing or fermentation operations to participate in the production of various liquid fermentation products such as beer or other fermented beverages, using the method of the present invention insofar as the need for a large amount of equipment to conduct the malting and mash steps, along with the need for significant product storage space, is removed. People setting up a simpler brewing or fermentation operation may wish to purchase the wort manufactured in accordance with the present invention for separate use, without the need to actually manufacture the wort on-site.

Referring to FIG. 2, the first step shown at 201 is the preparation of the admixture of water and the natural protein concentrate obtained from a non-cereal grain source. This would basically consist of mixing the protein concentrate with water, in an appropriate ratio. The ratio of water and protein concentrate used might vary dependent upon the desired profile of the finished wort but it will be understood that regardless of the particular ratio of water to natural protein concentrate from a non-cereal grain source, the use of this admixture in the wort preparation or fermentation processes of the present invention is contemplated to be within the scope of the present specification and claims.

In certain cases again dependent in large part upon the desired final profile of the wort being prepared, other ingredients along with the protein concentrate may be added to the water in the preparation of the admixture for use in the production of the wort. For example, one or more fermentable sugars may be added to the admixture, coloring agents, flavoring agents or bittering agents might all be added to the admixture to react with other ingredients in the wort as the admixture is boiled, or simply so that they are all incorporated into the wort when the wort is fermented in a later process step.

Other components may be added to the wort m addition to the natural protein concentrate and fermentable sugars. In one aspect of the invention these would include commonly used flavorings like hop extracts, herbs, brewer's caramel and other additives well known to those skilled in the art. Other embodiments would make use of other additives and flavorings or coloring well known in the art and suitable for preparing alcoholic beverages for consumption. The use of such added materials will thus be chosen based on the desired preferences of the brewer, or of the consumer for which the fermentation product is being prepared.

Following preparation of the protein water and admixture, the next step in the process of production of the wort outlined in FIG. 2, shown at 202, is the boiling of the admixture. The admixture would be brought to a boil and held at that temperature for a desired length of time. The boiling process is used to improve extraction of desirable components from the components of the wort, and is also operative to inactivate enzymes and microorganisms that may be present in the wort, and whose presence is undesirable during fermentation and subsequent steps of processing. The wort produced by the present method is suitable for boiling using standard techniques.

The duration of the boiling step will be determined based on the degree of extraction desired, or the time needed to inactivate enzymes or microorganisms. Typically the boiling stage will take from 5-10 minutes, but it is expected that other boiling times may also be used effectively when practicing the present process. Boiling may be performed in a variety of styles of equipment, including simple kettle, or more modern equipment that includes internal or external calandria, all of which are common to the art of brewing.

Following boiling, the hot wort is allowed to rest, shown at 203. The period of time may vary, but conveniently a time ranging from 0-30 minutes may be used. The resting step allows settling out of solids from the boiled wort (e.g. coagulated protein—often referred to as “trub”, vegetable matter such as hops or herbs). In some embodiments, a separate whirlpool vessel may be used for this stage of the wort production process.

Once the wort has had an opportunity to rest or settle, the impurities or other non-desirable components can be removed from the stratified wort. The wort might also be actively cooled while it is allowed to rest for purification purposes, or it might simply be allowed to passively cool in the environment of the production facility.

As outlined above, the wort produced in accordance with this method might be produced and then stored for subsequent use or for sale to other brewing or fermentation customers. Alternatively, in certain embodiments, the wort may be produced in accordance with this method and may be directly fed on into the remaining steps of the fermentation process of the present invention. The product, a wort for use in fermentation which is prepared using a natural protein concentrate from a non-cereal grain source in place of malt, is understood to be covered within the scope of the claims and specification herein.

Concentrated Wort Product:

In addition to the production of wort in a “ready to use” format for subsequent use, it is also contemplated that within the scope of the present invention is the means and method for the production of a concentrated wort product. Conceptually what is contemplated is the concentration of wort produced in accordance with the wort production method and parameters outlined herein to yield either a dry format or a wet format wort concentrate which in a concentrated form would be more compact or easy to ship, or perhaps more shelfstable, which concentrate could then subsequently be reconstituted by the addition of water into a wort of the appropriate concentration at the time that it was going to be used in a liquid fermentation process.

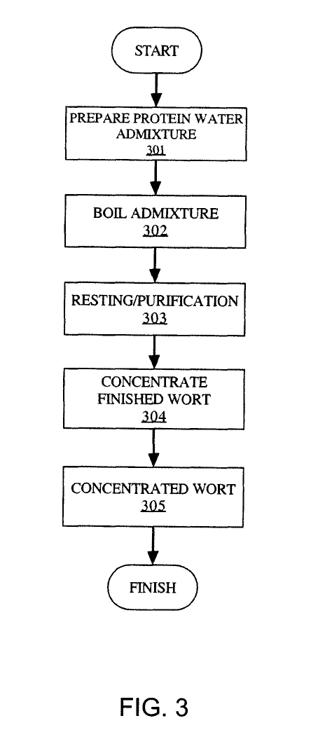

FIG. 3 demonstrates one method of the production of a concentrated wort. Shown at Step 301 in that Figure is the preparation of the protein and water admixture, which would effectively comprise the combination of a natural protein concentrate from a non-cereal grain source with water. As outlined elsewhere herein, the admixture might also comprise one or more additional fermentable sugars, bittering agents or coloring agents. Once the admixture is prepared, it is boiled, shown at Step 302.

The admixture would be brought to a boil and held at that temperature for a desired length of time. The boiling process is used to improve extraction of desirable components from the components of the wort, and is also operative to inactivate enzymes and microorganisms that may be present in the wort, and whose presence is undesirable during fermentation and subsequent steps of processing.

The boiled wort would be allowed to rest or would otherwise be purified, shown at Step 303. Purification of the wort, in any number of more or less elaborate means from something as simple as allowing the boiled wort to rest and lower temperature to other types of filtration or stratification of the boiled wort, are all contemplated within the scope of Step 303 as shown.

The final step in the production of the concentrated wort product as outlined in the method of FIG. 3 is the actual step of concentration of the wort, shown at Step 304.

The concentration step might itself comprise any type of a step or steps which could be used to create a concentrated wort in either a wet or dry format as otherwise outlined herein, Overall the idea of concentration of the wort is to yield a product which is either less voluminous or otherwise more shelf stable or desirable from a storage, sale or transportation perspective, which could be reconstituted by the addition of water at the appropriate time to yield a wort of the proper concentration by the addition of water. For example, the concentration Step 304 might comprise spray drying the wort to result in a spray dried concentrate which could be reconstituted by the addition or blending of the concentrate with water, or a wet concentrate could be created by removing a percentage of the water from the wort to result in a concentrate which could be brought back to the appropriate concentration for use by the reintroduction of a certain percentage or amount of water into the concentrated wort for blending, to result in the wort of a pre-identified desired concentration for use in the remainder of the fermentation process. The completion of the concentrated wort product in accordance with the method of the present invention is shown at Step 305 of this Figure.

Fermentation Using Natural Protein Concentrate:

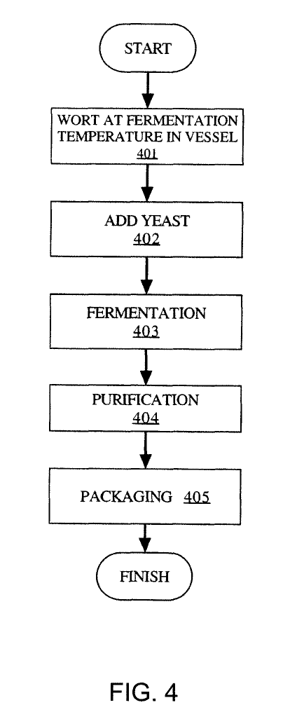

FIG. 4 is the first of a series of Figures demonstrating the fermentation process of the present invention which is desired or designed to result in the production of a liquid fermentation product which can be used in the production of alcoholic beverages and the like. The method of FIG. 4 contemplates the previous production or supply of wort prepared from a natural protein concentrate from a non-cereal grain source as outlined elsewhere herein. It will be shown further in some of the following Figures how the fermentation process of the present invention might include the wort production as a portion of the overall fermentation process, or the wort might be separately produced either at the same location or by a separate provider for use in the actual fermentation process of the present invention.

In order to commence the fermentation, the wort is brought to an appropriate fermentation starting temperature in a fermentation vessel of some kind. Placement of the wort at this initial temperature in a fermentation vessel is demonstrated at Step 401 of the Figure. Fermentation of the wort is initiated by the addition of live yeast cells, shown at 402. The particular strain of yeast added will depend on the style of fermentation product desired, and will be known to one skilled in the art of brewing. In traditional brewing methods, yeast is added a concentration of 1.25 million cells per mL per degree Plato. The Plato system is a measure of the sugar content in a wort commonly used by brewers, with 1° Plato equal to 0.004 difference in specific gravity and corresponding to a sucrose concentration of 1%. Using prior art methods of preparing fermented alcohol bases similar to that produced by the method of the present invention, a yeast pitching rate is typically ten-fold or more, or in the range of 20-30 million cells per mL per degree Plato is required.

It has been discovered that using the brewing process of the present invention the amount of yeast need to initiate fermentation may be significantly reduced from similar types of fermentations. For example, in the present process, yeast may be added at of 1.25 million cells per mL per degree Plato and still result in the efficient fermentation of the wort.

Following the addition of the yeast, the fermentation of the wort within the fermentation vessel is shown at Step 403. In traditional brewing methods varying the temperature of fermentation will vary the properties of the resultant fermentation product. For example, in the production of lager beers, it is common to ferment a temperature of 12-15° C. for 7-10 days, while for producing ale a temperature of about 20° C. for 4-7 days is typical. The present method is well-adapted for use at varying temperature and times in order to vary the nature of the resulting fermentation product. The precise time and temperature of fermentation will depend on the particular taste and character desired in the fermentation product. For example, shorter fermentation will result in a product with residual sugar and thus an apparent sweetness. In contrast, allowing fermentation to proceed to completion will result in a fermentation product with higher alcohol content, and a “drier” taste. In the present case, fermentation is allowed to proceed for the desired time, and at a desired temperature, both of which will be readily determined by the skilled brewer.

Following the completion of fermentation, the contents of the fermentation vessel can be purified, shown at 404, to remove spent yeast and the like from the completed fermented liquid. The contents of the fermentation vessel at the completion of the fermentation Step 403 is the liquid fermentation product, which following the purification shown at 404 would be ready for use. Shown as an additional final step in the embodiment of the fermentation method of FIG. 4 is the packaging of the completed liquid fermentation lo product, shown at Step 405. In some instances where the liquid fermentation product of the method of the present invention was in completed form at the completion of purification after fermentation, the packaging of the product, at 405, could be the packaging of the liquid fermentation product for retail sale in a completed beverage format. Alternatively, packaging of the liquid fermentation product of the fermentation process of the present invention could be the packaging of that liquid fermentation product for subsequent use in other beverage production or blending steps, as outlined elsewhere herein.

If desired, carbon dioxide can be injected at the bottling or packaging stage to enhance the carbonation of the product. In another aspect of the invention, the fermentation product may be filtered and then used in blending with other components to produce various alcoholic beverages. In yet another aspect it is anticipated that an unfiltered fermentation product might also be useful, and in those cases the fermentation product obtained by the present method could be used immediately.

It is specifically contemplated that the method of FIG. 4 could employ a fermentation wort, produced with a natural protein concentrate from a non-cereal grain source, which was produced in a separate time or in a separate location from the instigation of the fermentation process. It will also be understood however that the production of the wort itself might be produced at the same location as the conduct of the fermentation process and that the production of the wort, where taking place at the same location as the remainder of the fermentation process, could simply be conducted as the initial few steps to the remainder of the fermentation process i.e. that is to say that the wort could be produced, and following its production and cooling from the boiling of the wort and following any other purification steps desired to be taken with respect to the wort, the fermentation process could be immediately instigated.

One major benefit of the fermentation process of the present invention is that in the production of the liquid fermentation product of the present invention, as compared to traditionally brewed beer or the like which is produced in accordance with the prior art method along the lines shown in FIG. 1, the need for storage following the completion of fermentation is removed. By using the method of the present invention and omitting the storage step, a significant economic advantage over prior art methods of brewing is provided in that the overall brewing process can be reduced from 1-3 weeks or more. An additional advantage is also realized in that the present method requires less equipment than traditional methods of brewing. Thus, using the present method a fermentation product can be obtained within about 10 days, as compared to 3-4 weeks when using traditional methods of brewing.

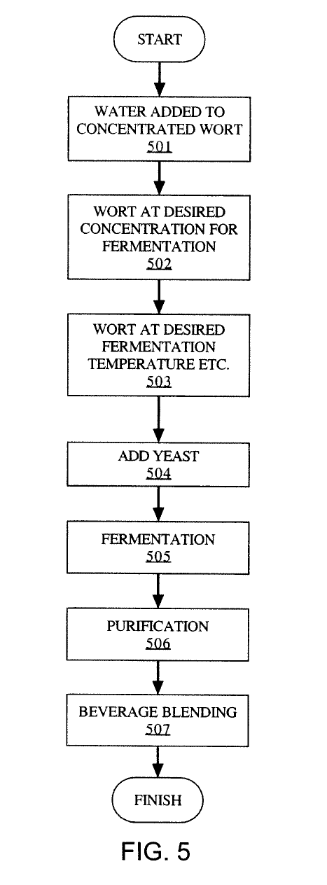

FIG. 5 demonstrates another embodiment of a fermentation method in accordance with the present invention. The primary difference between the embodiment demonstrated in FIG. 5 and that shown previously in FIG. 4 is that FIG. 5 is provided to demonstrate the use of the concentrated wort product in accordance with the method of production of concentrated wort outlined elsewhere herein, in the overall fermentation process. Specifically, the method of FIG. 5 comprises as its first step the reconstitution of the concentrated wort, shown at 501, by the addition of water to the concentrated wort product to achieve the desired concentration of that product for use in the following fermentation steps. As has been outlined elsewhere herein, it is contemplated that where a concentrated wort product were prepared that could be prepared in either a wet or a dry format. It is contemplated that the reconstitution of that concentrated wort product to the desired fermentation concentration would effectively comprise the addition of water and the combination of the water with the concentrated wort product by blending, mixing with the like, until the desired consistency as well as the desired concentration of the concentrated wort product back to a fermentation concentration were reached. Completion of the reconstitution of the concentrated wort product is shown at 502.

Following the reconstitution of the concentrated wort product, the reconstituted wort could be used, shown at 503 onwards, in the standard steps of the fermentation process previously described with respect to the method of FIG. 4. FIG. 5 does not show the packaging step, since it was desired to also demonstrate that in certain circumstances the liquid fermentation product of the process of the present invention may be used for example in subsequent beverage blending steps or the like such as is shown by the addition of Step 507 to this Figure.

Oxygen Injection:

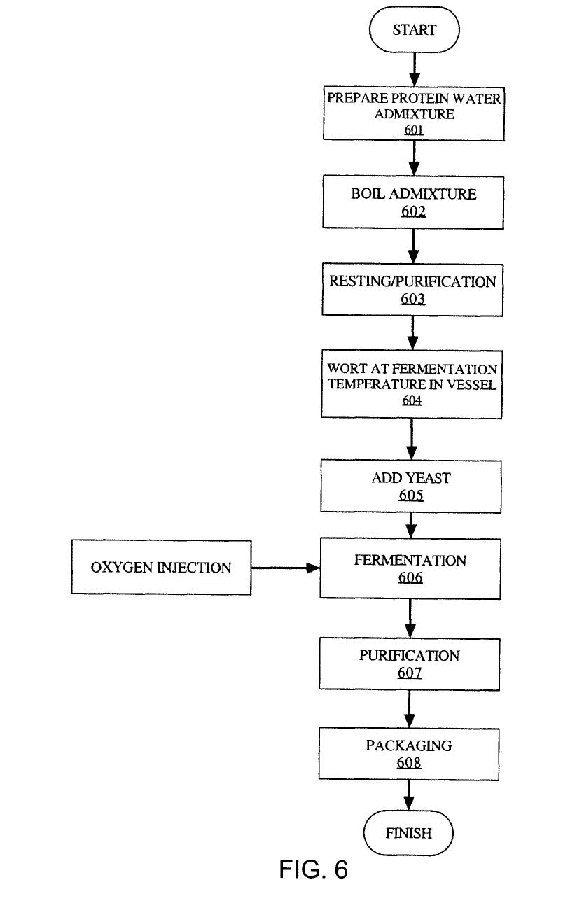

FIG. 6 demonstrates another embodiment of a fermentation process of the present invention for the production of a liquid fermentation product having the qualities outlined elsewhere herein. The process of FIG. 6 varies from the others previously demonstrated insofar as it first includes specifically the injection of oxygen into the fermentation stage of the process, but also this Figure demonstrates a process in which the production of the wort from a natural protein concentrate from a non-cereal grain source is shown in the first few steps of the process. As outlined elsewhere herein it is contemplated that in certain circumstances the preparation of the wort would be done remotely or at a separate time from the fermentation process but also is specifically contemplated that in other circumstances, such as the circumstances in which the process of FIG. 6 would be used, the wort could be produced at the same time or leading into the remainder of the fermentation process.

Referring then to the first couple of steps of the embodiment of FIG. 6, the production of the wort is shown. First shown at Step 601 is the production of the protein water admixture—this effectively comprises the blending of water with a natural protein concentrate from a non-cereal grain source for subsequent boiling in the production of wort. The address your mind optionally contain or comprise additional fermentable sugars, bittering agents, coloring agents or the like, as outlined elsewhere herein with respect to the production of the wort for use in the fermentation process is outlined herein. Following the production of the admixture at 601, the admixture is boiled. The boiling of the admixture is demonstrated at 602. The boiling of the admixture, to produce wort, results in the creation or production of a purified or otherwise optimized fermentation feedstock.

Resting the boiled wort accomplishes a couple of objectives, the first of which is to allow to cool to the appropriate fermentation temperature, but also potentially to allow for the stratification of the wort in its boiled form so that the impurities can in some fashion be removed therefrom. Resting and purification of the boiled wort is shown at 603.

Following boiling, and prior to the addition of the yeast, the wort is cooled in order to bring the temperature of the mixture to a temperature suitable for fermentation. Cooling times will vary depending on the volume of the batch, and the specific method of cooling used, neither of which are limiting to the operation of the present method. For example, in one aspect of the invention the wort is cooled to a temperature in the range of 8-10° C. over a period of 60 min. In other embodiments, the final temperature and cooling rate may be chosen based on the yeast strain used in fermentation, the style of fermentation product to be produced, as well as factors that will be readily known and considered by a skilled brewer. Once the wort is cooled or otherwise brought to the appropriate fermentation starting conditions in terms of temperature and the like, fermentation can be commenced within the fermentation vessel by the seeding of yeast into the wort. The addition of the yeast to the wort is shown at Step 605. The following conduct of the fermentation is shown at Step 606 in the Figure.

In order to enhance the onset of fermentation and stimulate proliferation of the yeast, it is often desirable to dissolve additional oxygen into the wort. Commonly, oxygen at 16-20 parts per million is injected to accomplish this purpose. Referring to FIG. 6 there is demonstrated the step of the injection of oxygen into the fermenting wort to aid in the proliferation of yeast. Oxygen injection into a fermentation process will be understood to those skilled in the art and on that basis the specific means or method of accomplishing the oxygen injection will be understood to be contemplated within the scope of the method outlined herein.

In other prior art fermentation processes, other nutrients might often also be added at this stage of the fermentation. For example, it is common in traditional fermenting methods to add compounds such as di-ammonium phosphate or urea, which are effective as yeast nutrients, in order to improve the rate of growth of the yeast culture during fermentation. It has been discovered that the use of the natural protein concentrate in the present brewing method obviates the need for these artificial additives. Thus, an additional advantage is provided in reducing the handling and materials required in the course of brewing when using the present method.

The fermentation process might automatically stop upon exhaustion of the yeast within the wort, or alternatively those skilled in the art will also be aware of different methods by which the fermentation could physically be arrested or stopped if it was desired to do so. The physical stopping of fermentation within the fermentation vessel is an optional step which could be included within the method of the present invention.

Upon reaching the completion of the fermentation process, which will likely be determined based upon testing or any number of parameters by the operator of the process, the contents of the fermentation vessel can be purified as shown at 607 to yield a purified liquid fermentation product. Also shown in the Figure at 608 is the packaging of that finished liquid fermentation product, and as outlined elsewhere herein and previously discussed, that packaging might comprise the preparation of retail packaging of the product if it were ready at that point for retail packaging for consumption as a beverage, or alternatively the packaging Step 608 might also comprise the packaging of the liquid fermentation product of the process of the present invention for subsequent use in the production of blended alcoholic beverages and the like. Optionally in the place of the packaging Step 608, and as outlined with respect to the other Figures and embodiments shown herein, additional beverage blending or completion steps might also be added following the completion of the fermentation and it will be understood that any type of a process resulting in the packaging or blending of the finished liquid beverage product based upon the product of the fermentation process of the present invention is contemplated within the scope hereof

Finishing Various Beverage Products:

The fermentation product resulting from the present invention is suitable for consumption as “beer” after the addition of hop extracts for bittering and aroma, as well as coloring. Alternatively, the fermentation product may be used as a neutral base in the production of other alcoholic beverages. For example, it may be desirable to add other flavorings, coloring or other suitable additive or to blend the fermentation product with products derived from other processes to produce unique flavors and styles that are desirable to consumers.

A number of types of finishing steps could be conducted upon the liquid fermentation product of the method of the present invention to yield final beverages or beverage components with different qualities. For example beyond basic purification steps, the liquid fermentation product of the present invention might be carbonated, distilled or otherwise treated to yield beverage components or beverages with varying profiles as desired by the user of the process.

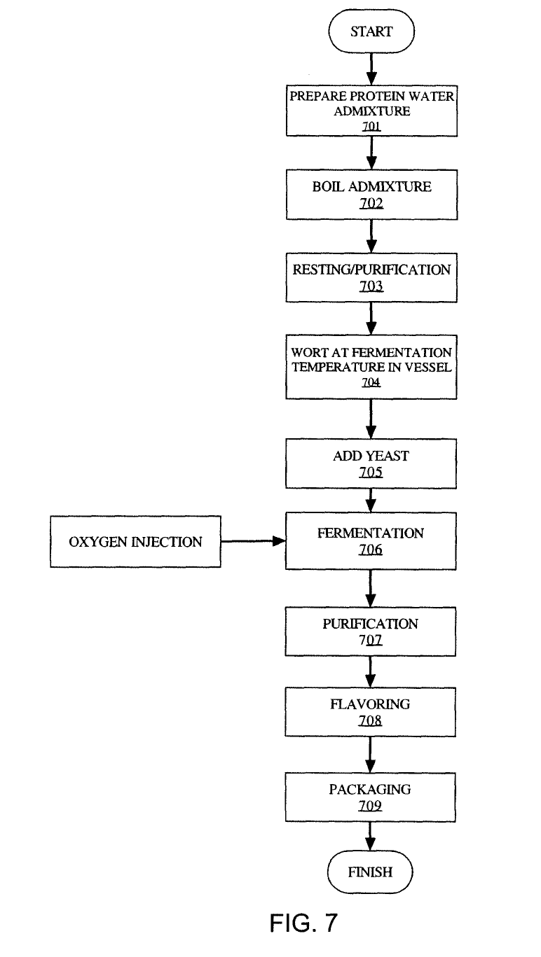

As outlined elsewhere herein, it is contemplated that in particular circumstances the liquid fermentation product of the fermentation method of the present invention would effectively be a finished beverage product at the completion of fermentation and purification. There are other circumstances however within which the liquid fermentation product of the fermentation method of the present invention might require the incorporation or addition of various flavorings, following completion of the fermentation steps, to yield a completed beverage product. FIG. 7 is intended to demonstrate the production of a liquid fermentation product in accordance with the method of the present invention including the addition of flavorings to the finished fermentation product to yield a finished beverage.

The method shown in FIG. 7 includes the same steps in terms of the production of the wort and subsequent fermentation as are shown in FIG. 6. The only difference in the method of FIG. 7 versus that of FIG. 6 is that the addition of flavorings to the finished fermented beverage product is shown at the completion of that method. Specifically, there is a flavoring step 708 shown following purification of the liquid fermentation product which is intended to convey through its demonstration in this Figure the incorporation of potentially one or more flavoring compounds into the liquid fermentation product of the method of the present invention to yield a finished flavored beverage. Following the flavoring of the liquid fermentation product of the process of the present invention, shown at Step 708, the finished flavored beverage which would be yielded by that step could be packaged for final use, consumption or sale.

To demonstrate some of the finished liquid fermentation products including the incorporation of flavors which are contemplated to be within the scope of the present invention, it is necessary to consider that the basic liquid fermentation product of the process of the present invention would effectively comprise a fermented alcoholic beverage base to which various flavorings could be added to yield different types of products. For example different types of flavoring compounds could be added to yield a finished beverage or finished liquid fermentation product that had the taste or flavor profile of beer—the flavoring added to be beverage base might in fact be beer or other flavoring compounds used to flavor beers. By the addition of one or more fruit flavorings, fruit type alcoholic cooler beverages could be yielded. It will be understood that the production of any number of different types of flavored liquid fermentation products are beverages by the addition of one or more flavorings to the basic liquid fermentation product of the method of the present invention are all contemplated to be within the scope hereof.

Blended Beverage Product:

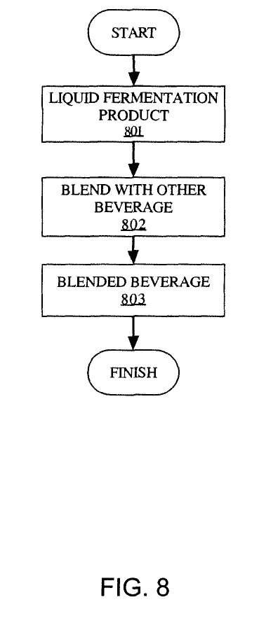

FIG. 8 demonstrates one further extension of the fermentation method of the present invention. Specifically, beyond the addition of basic flavorings to the liquid fermentation product of the process of the present invention it is also considered that the liquid fermentation product of the process of the present invention could be used as a blending component along with other liquids to again produce a blended liquid fermentation product comprising a larger percentage of the blended product along with the fermentation product of the present method. For example, it was outlined above with respect to FIG. 7 that the liquid fermentation product of the process of the present invention could be flavored with one or more flavoring compounds to taste like beer. It is also however contemplated that rather than simply flavoring a batch of the liquid fermentation product of the present invention to taste like beer, the liquid fermentation product of the present invention could be blended with traditionally produced beer, m a ratio of a larger amount of beer than would be necessary necessarily to only flavor the liquid fermentation product, to yield a blended beer or blended beverage which used a proportion of the liquid fermentation product of the present invention, beyond flavoring, for other beneficial reasons. For example it may be the case that the production of the liquid fermentation product in accordance with the method of the present invention was cheaper or more efficient to accomplish than the production of traditional beer and that the overall cost of production of beer might be reduced by blending a substantial portion of the product of the present fermentation method with traditionally produced beer. Beyond the ability to perhaps reduce the financial cost of production of beer, there may also be other benefits to the incorporation of a larger portion of the liquid fermentation product of the process of the present invention along with other beverages, including the gluten-free aspect of the product and method of the present invention outlined elsewhere herein, which yield a substantial benefit.

FIG. 8 is intended to demonstrate the blending of a beverage using the liquid fermentation product of the present invention as a substantial blending component.

Shown in the figure at 801 is the use of the liquid fermentation product of the fermentation method of the present invention as the starting ingredient or as one of the blending components in a blended beverage. The liquid fermentation product, shown at 801, would be blended with another beverage, shown at blending Step 802, to yield a blended beverage, shown at 803. As outlined elsewhere above, it is specifically contemplated that one particular type of a blended beverage which could be produced in accordance with the method of the present invention would be to produce a blended beer which would be a quantity of beer or blended with a quantity of the liquid fermentation product of the present invention which it is felt would yield a significant economic advantage in the production of beer with no significant change in the final flavor profile of the finished product. It will be understood however that any number of different blended beverages in which it was desired to provide some degree of a fermented alcoholic base such as the liquid fermentation product of the present invention could be conceived by one skilled in the art of the production or design of beverage products and that all such products resulting from the blending of the liquid fermentation product of the present invention with other beverage components are contemplated within the scope of the present invention.

Gluten Free Product:

Another object of the invention is to provide a simplified method of brewing a gluten-free fermentation product. In traditional brewing methods, the use of cereals like wheat, rye, oats or triticale results in the inclusion of the protein complex gluten in the wort, and thus in the fermentation product. In those who are genetically predisposed to gluten intolerance, otherwise known as celiac disease, the presence of gluten in foodstuffs or beverages can have significant physiological effects. In those sufferers, ingestion of gluten causes an autoimmune reaction, leading to impaired absorption of nutrients, and in some gastrointestinal discomfort. Persons with celiac disease are advised to avoid gluten containing products in order to avoid the significant health risks that attend this syndrome. However, this also means avoiding consumption of many products which are desirable, one of which is fermentation products such as beer.

Various methods of producing gluten-free beers have been disclosed in the patent literature. Typically though, they involve adaptations of traditional brewing methods to grains that lack gluten. For example, it is possible to use millet, buckwheat, rice, amaranth or quinoa to produce a malted product that is adaptable to traditional brewing processes. Alternatively, chemical and enzymatic treatment of non-gluten containing grains or potatoes has also been successful in producing extracts that can be included in wort suitable for fermentation. However, each of these prior art methods require additional steps, handling or materials in order to produce a gluten-free fermentation product. Thus, they add to the cost and complexity of the brewing process.

In contrast, in the present invention the source of the natural protein concentrate may be conveniently chosen from a non-gluten containing source. For example, peas, soy, rice and potatoes are all sources of natural protein that are adaptable to the present brewing process. Likewise, fermentable sugars derived from corn will also lack gluten, and certified gluten-free hops are available commercially. Other common additives like brewer's caramel used for coloring can also be obtained gluten-free and used in the present brewing process.

When these components are combined and brewed using the method of the present invention, it is thus possible to produce a gluten-free fermentation product. This gluten-free fermentation product is useful in the production of a gluten-free beer, or in blending with other gluten-free flavorings or additives produce a gluten-free alcoholic beverage.

The foregoing is considered as illustrative only of the principles of the invention. Further, since numerous changes and modifications will readily occur to those skilled in the art, it is not desired to limit the invention to the exact construction and operation shown and described. Accordingly, all suitable changes or modifications in structure or operation which may be resorted to are intended to fall within the scope of the claimed invention.

What is claimed is:

1. A method for the production of a wort for use in the production of liquid fermentation products, said wort containing a natural protein concentrate from a non-cereal grain source in the place of malt, said method comprising:
a) combining a natural protein concentrate from a non-cereal grain source with water to create a protein water admixture;
b) boiling the protein water admixture to produce a wort; and
c) purifying the boiled wort by removal of non-desired compounds or impurities.

2. The method of claim 1 wherein the boiled wort is purified by allowing the boiled wort to rest, stratifying impurities for removal, and subsequently removing any non-desirable settled compounds from the stratified wort.

3. The method of claim 1 further comprising cooling the boiled wort, during or following the purification step.

4. The method of claim 1 wherein at least one fermentable sugar is added to the protein water admixture.

5. The method of claim 4, wherein the at least one fermentable sugar is at least one of sucrose, fructose, glucose, molasses and honey.

6. The method of claim 1, wherein a bittering agent is added to the protein water admixture.

7. The method of claim 6 wherein the bittering agent is hops or a natural extract from hops.

8. The method of claim 1 wherein at least one coloring agent is added to the protein water admixture.

9. The method of claim 8 wherein the at least one coloring agent is caramel.

10. The method of claim 1 wherein the natural protein concentrate is produced from a gluten-free source.

11. The method of claim 1 further comprising concentrating the wort once the purification is completed, yielding a concentrated wort which could subsequently be reconstituted to its proper concentration for use in fermentation by the addition of water.

12. The method of claim 11 wherein the concentration of the wort results in a concentrated wort in a dry format.

13. The method of claim 11 wherein the concentration of the wort results in a concentrated wort in a wet format.

14. The product, a wort for use in the production of liquid fermentation products without reliance on malt, produced in accordance with the method of claim 1.

15. A method of production of a liquid fermentation product without reliance on malt, said method comprising:
a) initiating fermentation within a fermentation vessel by combining yeast with a wort containing a natural protein concentrate from a non-cereal grain source in place of malt; and
b) allowing fermentation within the fermentation vessel to continue at a selected fermentation temperature for a period of time being the fermentation time period, until the desired liquid fermentation product is produced therein.

16. The method of claim 15 further comprising, in advance of initiation of fermentation within a fermentation vessel, producing the wort for use in the remainder of the method by:
c) combining a natural protein concentrate from a non-cereal grain source with water to create a protein water admixture;
d) boiling the protein water admixture to produce a wort; and
e) purifying the boiled wort by removal of non-desired compounds or impurities.

17. The method of claim 16 further comprising cooling the wort in advance of its use in the initiation of fermentation within the fermentation vessel.

18. The method of claim 15 further comprising stopping the fermentation within the fermentation vessel once the desired liquid fermentation product is produced.

19. The method of claim 15 wherein yeast are added to the wort at a concentration in the range of from 0.5-2.0 million cells per degree Plato.

20. The method of claim 15 further comprising the injection of oxygen into the wort within the fermentation vessel to aid in the initiation of fermentation.

21. The method of claim 20 wherein oxygen is injected into the wort within the fermentation vessel at a concentration in the range of 5-40 parts per million.

22. The method of claim 15 further comprising finishing the liquid fermentation product following the completion of fermentation, by conducting at least one of filtering; carbonation; blending; coloring; and flavoring the liquid fermentation product.

23. The method of claim 22 wherein blending comprises blending the liquid fermentation product with a product of a second process.

24. The method of claim 23 wherein the second process comprises fermentation of a malted grain.

25. The method of claim 24 wherein the second process comprises the production of a fully fermented beer.

26. The method of claim 23 wherein the second process comprises a distillation process.

27. The method of claim 15 wherein the fermentation is conducted within the fermentation vessel for a period of time in the range of 4 to 14 days.

28. The method of claim 15 wherein the fermentation temperature is in the range of 10 to 22 degrees Celsius.

29. The method of claim 15 wherein the natural protein concentrate is produced from a gluten-free source.

30. The product, a liquid fermentation product, of the process of claim 15.
